(19) United States
(12) Patent Application Publication
(10) Pub. No.: US 2005/0057079 A1
(43) Pub. Date: Mar. 17, 2005

(54) Multi-functional chair

(76) Inventor: Tom Lee, Tao Yuan City (TW)

Correspondence Address: PRO-TECHTOR INTERNATIONAL, 20775 Norada Court, Saratoga, CA, 95070-3018, US

(21) Appl. No.: 10/665,065

(22) Filed: Sep. 17, 2003

(51) Int. Cl. B60N 2/32

(52) U.S. Cl. 297/118

(57) ABSTRACT

A multi-functional chair includes a seat having a front end and a rear end, a first foot having a top pivotally mounted to the front end of the seat, a second foot having a fastening portion and a top pivotally mounted to the rear end of the seat, a back having one end connected to the second foot, a first extension having a first end pivotally mounted to the front end of the seat, a second extension having one end pivotally mounted to a second end of the first extension, and a connection having one end pivotally mounted to the first foot at a position close to the top of the first foot. The connection also has fastening portions to be selectively fastened to the fastening portion of the second foot to from furniture with different functions.

### BACKGROUND OF THE INVENTION

1. Field of the Invention

The invention relates to a chair, and more particularly to a multi-functional chair.

2. Description of the Related Art

A typical chair, such as a deck chair, an office chair, a stool, a sex chair (a high chair for sex), only has a single purpose. However, the sex chair is rarely seen in the family house because a person may feel embarrassed if the sex chair is disposed in his or her house. Therefore, the sex chair is often seen in the motel. In addition, a ladder is sometimes but not often needed in the daily life. The person has to uneconomically buy a ladder, which occupies a lot of space in the family house.

Consequently, the product will be more valuable if it may be configured such that it may normally serve as a deck chair, and sometimes serve as a sex chair or a ladder.

### SUMMARY OF THE INVENTION

An object of the invention is to provide a multi-functional chair, which has a widened usage range and may be transformed to serve as a deck chair or a sex chair.

Another object of the invention is to provide a multi-functional chair, which has a widened usage range and may be transformed to serve as a ladder.

To achieve the above-mentioned objects, the multi-functional chair of the invention includes a seat having a front end and a rear end, a first foot having a top pivotally mounted to the front end of the seat, a second foot having a fastening portion and a top pivotally mounted to the rear end of the seat, a back having one end connected to the second foot, a first extension having a first end pivotally mounted to the front end of the seat, a second extension having one end pivotally mounted to a second end of the first extension, and a connection having one end pivotally mounted to the first foot at a position close to the top of the first foot. The connection also has fastening portions to be selectively fastened to the fastening portion of the second foot.

Accordingly, the fastening portions of the connection may be selectively fastened to the fastening portion of the second foot to form furniture with different functions.

### BRIEF DESCRIPTION OF THE DRAWINGS

FIG. 1 is a schematic front view of a preferred embodiment of the invention.

FIG. 2 is a schematic side view of the preferred embodiment of the invention.

FIG. 3 is a schematic side view showing the usage of the preferred embodiment of the invention.

FIG. 4 is a schematic front view showing the usage of the preferred embodiment of the invention.

FIG. 5 is a schematic side view showing the usage of the preferred embodiment of the invention.

### DETAILED DESCRIPTION OF THE INVENTION

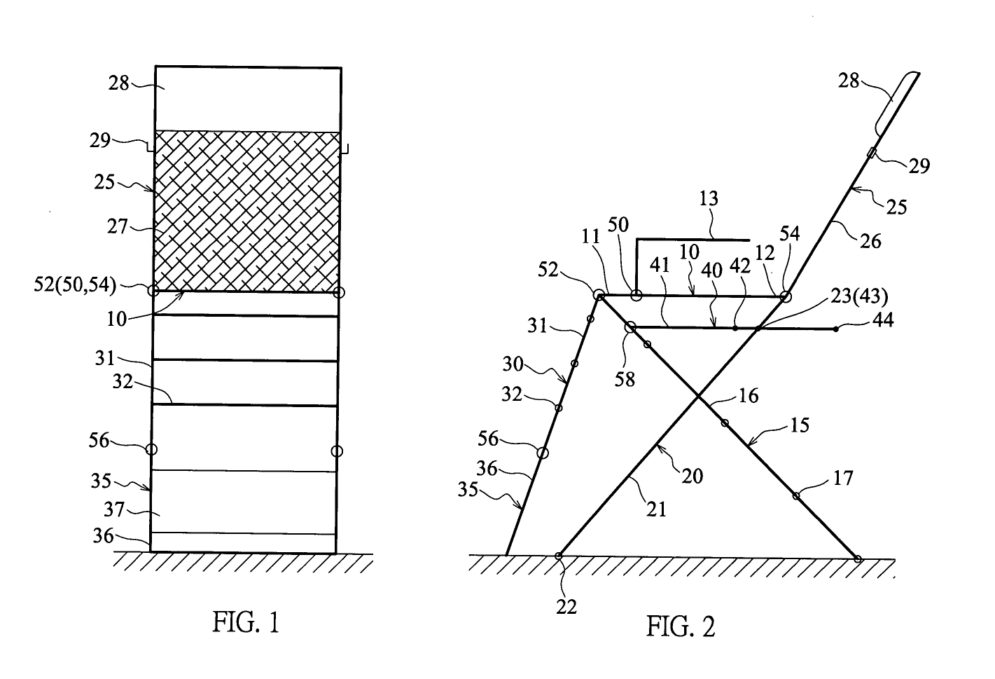

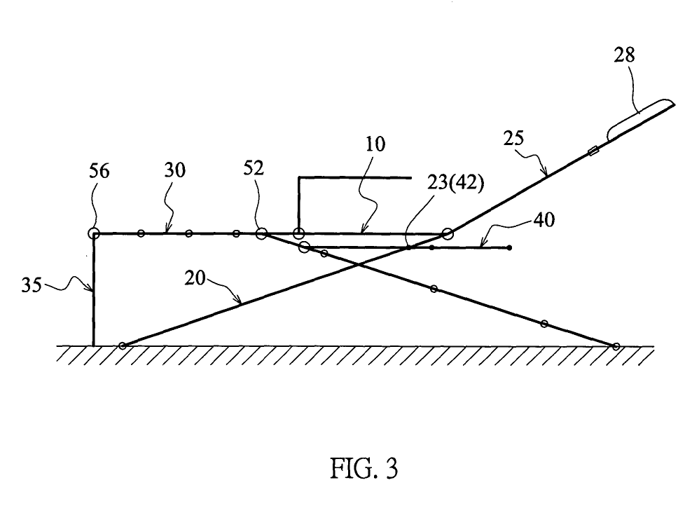

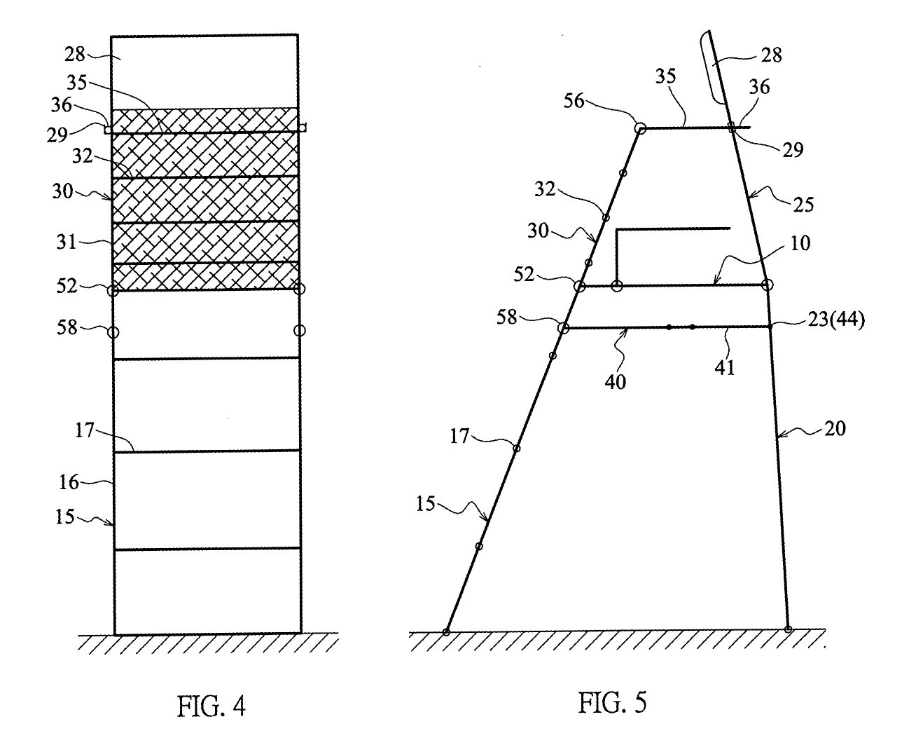

Referring to FIGS. 1 and 2, the multi-functional chair of the invention includes a seat 10, a first foot 15, a second foot 20, a back 25, a first extension 30, a second extension 35 and a connection 40.

The seat 10 is a plate having a front end 11, a rear end 12, and two lateral sides pivotally mounted to two armrests 13 via two first pivotal structures 50. Each of the armrests 13 may be rotated to change its angle, and then it is fastened to the first pivotal structure 50.

The first foot 15 includes two lateral links 16, the top of each of which is pivotally mounted to the front end 11 of the seat 10 via a second pivotal structure 52. Each of a plurality of transverse links 17 is fastened to the lateral links at the same height.

The second foot 20 includes two lateral links 21 and a transverse link 22. A top of each of the lateral links 21 is fastened to the rear end 12 of the seat 10 via a third pivotal structure 54. A fastening portion 23, which may be a protruding post, is attached to each of the two lateral links 21 at a position close to the top thereof. The transverse link 22 connects two bottoms of the lateral links 21 so as to enhance the structure.

The back 25 includes two lateral links 26 and a canvas piece 27 therebetween. The lateral link 26 and lateral link 21 of the second foot 20 defines the same link, and an angle of 10 degrees is formed between the two links. A headrest 28 is mounted to a top of the back 25, and two fasteners 29 are attached to two sides of the back 25.

The first extension 30 includes two lateral links 31, and a plurality of transverse links 32 is horizontally attached to the lateral links 31 at different heights. One end of each of the lateral links 31 is pivotally mounted to the front end of the seat 10 via the second pivotal structure 52.

The second extension 35 includes two lateral links 36 and a plate 37 between the two lateral links 36. One end of each of the two lateral links 36 is pivotally mounted to another end of the corresponding lateral link 31 of the first extension 30 via a fourth pivotal structure 56.

The connection 40 includes two links 41. One end of each link 41 is pivotally mounted to an approximate top of the corresponding lateral link 16 of the first foot, 15 via a fifth pivotal structure 58. A first fastening portion 42, a second fastening portion 43 and a third fastening portion 44, which are to be selectively fastened to the fastening portion 23 of the second foot 20, are formed or mounted to the connection 40. The first, second and third fastening portions 42, 43 and 44 may be a through hole, through which the fastening portion 23 of the protruding post type on the second foot may passes for fastening.

According to the above-mentioned structure, as shown in FIGS. 1 and 2, when the second fastening portions 43 of the two links 41 of the connection 40 are fastened to the fastening portions 23 of the second foot 20, a high chair is formed and may serve as a sex chair. In this case, the feet of a woman may rest on the armrests 13, which may be rotated in two directions. The user may adjust the rotating angle of the armrests 13 and then fix the armrests 13.

As shown in FIG. 3, a deck chair may be formed by performing the following steps. First, the first fastening portions 42 of the two links 41 of the connection 40 are fastened to the fastening portions 23 of the second foot 20. Then, the first extension 30 is rotated to be in a horizontal state. Next, the second pivotal structure 52 is fastened tightly to be located in the same plane as the seat 10. Then, the second extension 35 is rotated to be in a vertical state. Next, the fourth pivotal structure 56 is fastened tightly.

As shown in FIGS. 5 and 6, a ladder may be formed by performing the following steps. First, the third fastening portions 44 of the two links 41 of the connection 40 are fastened to the fastening portions 23 of the second foot 20. Then, the first extension 30 is rotated to align with the first foot 15. Next, the second pivotal structure 52 is fastened tightly. Then, the second extension 35 is rotated to be in a horizontal state. Next, the fourth pivotal structure 56 is fastened tightly. At this time, the lateral links 36 of the second extension 35 may be engaged with the fasteners 29 at two sides of the back 25 to make the multi-functional chair reach the highest height. The transverse link 17 of the first foot 15, and the transverse link 32 of the first extension 30 may serve as stairs.

The multi-functional chair of the invention may be turned into various patterns of furniture. Usually, the multi-functional chair may be turned into a deck chair that is most often used. Sometimes, it may be turned into a sex chair or a ladder. Thus, the multi-functional chair is quite economic and practical and can prevent the seldom-used furniture from occupying the space in the house.

Furthermore, since the multi-functional chair may serve as a sex chair, it may be turned into a deck chair, which completely has no showing of the sex chair. That is, the function of the sex chair is hidden so that the user may relaxedly put the multi-functional chair in the house without worrying about strange thought from other people.

In addition, several transverse links also may be horizontally attached to the second foot 20 and the back 25, and the sides of the second foot 20 and the back 25 may serve as a climb ladder. In this case, the canvas piece 27 of the back 25 has to be disassembled.

Furthermore, a detachable canvas piece also may be attached to the first extension, and a user may put his or her feet on the canvas piece when the multi-functional chair is used as a deck chair. The top segment of the back 25 may be designed to be foldable so that the headrest 28 may be folded and received in the back 25 when the multi-functional chair is used as a climb ladder.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A multi-functional chair, comprising:
a seat having a front end and a rear end;
a first foot having a top pivotally mounted to the front end of the seat;
a second foot having a top pivotally mounted to the rear end of the seat, and a fastening portion;
a back having a one end connected to the second foot;
a first extension having a first end pivotally mounted to the front end of the seat;
a second extension having one end pivotally mounted to a second end of the first extension; and
a connection having one end pivotally mounted to the first foot at a position close to the top of the first foot, and a plurality of fastening portions to be fastened to the fastening portion of the second foot.

2. The multi-functional chair according to claim 1, wherein the back and the second foot form an angle.

3. The multi-functional chair according to claim 1, further comprising armrests pivotally mounted to two sides of the seat.

4. The multi-functional chair according to claim 1, wherein the first foot comprises two lateral links and at least one transverse link.

5. The multi-functional chair according to claim 1, wherein the first extension comprises two lateral links and at least one transverse link.

6. The multi-functional chair according to claim 1, wherein the second extension comprises two lateral links and a plate.

7. The multi-functional chair according to claim 1, further comprising a headrest attached to a top of the back.

8. The multi-functional chair according to claim 1, wherein the fastening portion of the second foot is a protruding post.

9. The multi-functional chair according to claim 1, wherein the fastening portion of the connection is a through hole.

10. The multi-functional chair according to claim 6, further comprising two fasteners attached to two sides of the back, and the lateral links of the second extension are engaged with the fasteners.
